(19) United States
(12) Patent Application Publication
(10) Pub. No.: US 2023/0416501 A1
(43) Pub. Date: Dec. 28, 2023

(54) HYDROPHOBIC ALUMINUM NITRIDE POWDER AND METHOD FOR PRODUCING THE SAME

(71) Applicant: TOKUYAMA CORPORATION, Shunan-shi, Yamaguchi (JP)

(72) Inventors: Yoshitaka INAKI, Shunan-shi (JP); Hisamori INAGAWA, Shunan-shi (JP)

(73) Assignee: TOKUYAMA CORPORATION, Shunan-shi, Yamaguchi (JP)

(21) Appl. No.: 18/036,364

(22) PCT Filed: Dec. 13, 2021
(86) PCT No.: PCT/JP2021/045777

§ 371 Date: May 10, 2023

(30) Foreign Application Priority Data
Dec. 15, 2020 (JP) 2020-207275

(51) Int. Cl. C08K 9/06; C09C 1/40; C09C 3/12

(52) U.S. Cl. CPC C08K 9/06; C09C 1/40; C09C 3/12

(57) ABSTRACT

A hydrophobic aluminum nitride powder of the present invention has a hydrophobicity of 1 to 45. The carbon content derived from a hydrophobizing agent is in a range of 0.1 to 0.5 mass %, and the hydrophobizing agent is a silane compound.

### TECHNICAL FIELD

The present invention relates to a novel hydrophobic aluminum nitride powder. More specifically, the present invention relates to an aluminum nitride powder with hydrophobic properties developed by a surface treatment with a silane compound.

### BACKGROUND ART

In recent years, high integration of semiconductor devices has been advanced in response to a demand for smaller and sophisticated electronic components. This trend gives rise to a growing use of a heat dissipation material for efficiently releasing heat generated from the devices, as well as creating a demand for further improved heat dissipation performance. In order to release heat generated from semiconductor devices to a heat sink, a chassis or the like, a wide range of types and forms of heat dissipation materials are disposed in various paths. Among them, a heat-dissipating resin material filled with high thermal conductive filler powder is growing in market demand because it comes in a wide variety of types and a number of forms.

Typical examples of such a high thermal conductive filler include alumina, aluminum nitride, boron nitride, zinc oxide, and magnesium oxide. A known heat-dissipating resin material containing any of these fillers comes in the form of a heat dissipation sheet, a semiconductor sealing material, heat dissipation grease, a heat dissipation adhesive or the like.

Among the aforementioned fillers, aluminum nitride (AlN) powder is a highly promising heat-dissipating filler because it has especially good thermal conductivity, which is several tens of times as high as that of silica and five times as high as that of alumina. Further, for use with electronic devices where high insulation properties are required, a filler to be filled in resin needs to be chemically stable and free from releasing ionic impurities.

However, although AlN powder is highly insulating, it is susceptible to hydrolysis when in contact with water, with result of producing ammonium ions. As such, the use of an article formed from a resin composition filled with AlN powder has been restricted in applications where high insulation properties are required. If such an article (AlN-containing resin) is in contact with water or under a high humidity atmosphere, water intrudes into the article and comes in contact with AlN in the article, causing the AlN to be hydrolyzed.

Patent Document 1 proposes an AlN powder with water resistance developed by a surface treatment with orthophosphoric acid. However, a phosphorous compound has a risk of eluting phosphate ions and, thus, is avoided in electronic materials that need to be highly insulating. Further, an epoxy resin is often containing an alkaline curing agent such as amine. Accordingly, when the AlN powder surface-treated with orthophosphoric acid is contained in the epoxy resin, the alkaline curing agent reacts with a phosphate group, leading to a loss of an aluminum phosphate compound coating formed on the surface of AlN particles. As a result, the water resistance of AlN present in the epoxy resin is reduced.

Patent Document 2 proposes to forma silicon oxide coating layer on the surface of AlN to improve moisture resistance. More specifically, the silicon oxide coating layer formed on the surface serves to suppress the hydrolysis of the AlN in contact with water. However, silicon oxide, which has low thermal conductivity, makes the AlN less thermally conductive. In addition, the surface treatment for coating the AlN with silicon oxide is likely to cause the agglomeration of particles, which may inhibit the AlN from being filled into resin.

Patent Document 3 teaches surface-treating an AlN powder with an organosilane hydrophobizing agent having a long-chain alkyl group with 9 to 15 carbon atoms to improve water resistance at room. temperature. However, although the AlN powder treated with such a hydrophobizing agent having a highly hydrophobic group with a long-chain alkyl group exhibits extremely high hydrophobic properties, it does not have sufficient water resistance in resin. More specifically, this powder, when filled in resin, cannot be sufficiently prevented from being hydrolyzed (in the resin) by water penetrating through the resin. There is a room for further improvement.

Patent Document 4 proposes an aluminum nitride powder surface-treated with alkoxy modified silicone. Patent Document 5 proposes a ceramic powder coated with an organic compound produced by a reaction with a silane coupling agent or a titanium coupling agent.

However, although the aluminum nitride powder surface-treated with alkoxy modified silicone of Patent Document 4 has high water resistance (hydrolysis resistance) in powder form, it does not have sufficient water resistance when contained in resin as in Patent Document 3. This needs to be improved.

The same applies to an aluminum nitride powder surface-treated with the technique of Patent Document 5. That is, such an aluminum nitride powder does not have sufficient water resistance when contained in resin.

The above-described problem is crucial especially when aluminum nitride powder is composed of particles with a relatively small particle diameter.

### PRIOR ART DOCUMENTS

### Patent Documents

Patent Document 1: JP-A-9-202608

Patent Document 2: JP-A-2004-83334

Patent Document 3: JP-A-2000-129160

Patent Document 4: JP-A-2005-104765

Patent Document 5: JP-A-60-123561

### SUMMARY OF THE INVENTION

### Problems to be Solved by the Invention

Therefore, an object of the present invention is to provide a hydrophobic aluminum nitride powder that, when filled in resin, is capable of exhibiting high water resistant properties, so that the hydrolysis of aluminum nitride in contact with water intruding into the resin is suppressed significantly.

### Means for Solving the Problems

As a result of intensive study made to achieve the aforementioned object, the present inventors have found that when aluminum nitride (AlN) powder is filled in resin, the hydrolysis of AlN in contact with water penetrating through the resin progresses rapidly when the water intruding into the resin is pooled in a gap formed at the interface between particles of the AlN powder and the resin. It has also been found that when AlN powder is excessively hydrophobized with a hydrophobizing agent in an attempt to achieve higher water resistance, the powder has a reduced affinity for resin, which unintentionally accelerates the formation of the gap, resulting in progressive hydrolysis of AlN. Based on these findings, a further study has been made, leading to the discovery that AlN powder with a certain level of hydrophobic properties developed by a surface treatment with a hydrophobizing agent exhibits both hydrophobic properties and a moderate affinity for resin and, thus, can be effectively prevented from being hydrolyzed by water intruding into resin. Thus, the present invention has been completed.

The present invention provides a hydrophobic aluminum nitride powder having a hydrophobicity of 1 to 45. In the hydrophobic aluminum nitride powder, a carbon content derived from a hydrophobizing agent is in a range of 0.1 to 0.5 mass %, and the hydrophobizing agent is a silane compound.

It is suitable for the hydrophobic aluminum nitride powder of the present invention that:
(1) The silane compound has a molecular weight of not more than 400;
(2) The hydrophobic aluminum nitride powder has a hydrophobicity in a range of 1 to 30;
(3) A particle diameter D₅₀ at a cumulative volume of 50% is 0.5 to 20 μm in a particle size distribution as measured with an ethanol solvent by a laser diffraction and scattering-type particle size distribution meter; and
(4) A decomposition rate (hereinafter, may be referred to as “rate of basal hydrolysis in resin”) of aluminum nitride is 25% or less as measured after a test where an article with a diameter of 10 mm and a thickness of 1.2 mm that is formed from a resin composition containing the hydrophobic aluminum nitride powder in an amount of 25 parts by mass with respect to 100 parts by mass of an epoxy resin containing an amine curing agent in an amount of 20 mass % is immersed in 50 g of ion exchange water at 120° C. for 90 hours.

The present invention further provides a resin composition including the above-described hydrophobic aluminum nitride powder.

In the resin composition, it is preferable that:
(1) The hydrophobic aluminum nitride powder is included in an amount of 10 to 1500 parts by mass with respect to 100 parts by mass of a resin; and
(2) The resin is an epoxy resin or a (meth)acrylic resin.

The present invention further provides a method for producing a hydrophobic aluminum nitride powder, including the following steps:
preparing a nonhydrophobic aluminum nitride powder as a base powder; and
mixing the base powder with a silane compound to surface-treat the base powder so that a hydrophobicity is 1 to and a carbon content derived from the silane compound is in a range of 0.1 to 0.5 mass %.

In the production method, it is desirable that the silane compound has a molecular weight of not more than 400.

### Effects of the Invention

The hydrophobic aluminum nitride powder of the present invention is surface-treated with a silane compound as a hydrophobizing agent, so that the hydrophobicity is in a range of 1 to 45 and the carbon content derived from the hydrophobizing agent (silane compound) applied to the surface of particles is in a range of 0.1 to 0.5 mass %. The thus moderately hydrophobized powder has not only significantly lower hydrolyzability but also an increased affinity for resin, so that the powder is less likely to be hydrolyzed also in a resin composition (resin article).

For example, in an epoxy resin article containing a predetermined amount of this hydrophobic aluminum nitride powder, the hydrolyzability (rate of basal hydrolysis in resin) of the AlN powder is measured to be 25% or less as described in Examples below (see Examples for detailed measurement conditions.) More specifically, in the hydrophobic AlN powder of the present invention having the aforementioned hydrophobicity and carbon content derived from the hydrophobizing agent, the carbon derived from the hydrophobizing agent is present on the surface of particles in the definite proportions, serving to greatly increase the affinity for resin. Thus, the AlN powder is allowed to be present inclose contact with a resin component in various resin articles and exhibits high hydrolysis resistance (water resistance) also in the resin articles. In addition, when the rate of basal hydrolysis in resin as measured under the conditions is 25% or less, the AlN powder exhibits equally low hydrolyzability even in articles with different compositions, such as an article containing another filler besides the AlN powder and an article containing another resin (such as acrylic resin) instead of epoxy resin. This astonishing fact leads to the presumption that the hydrophobic AlN powder of the present invention having the aforementioned hydrophobicity and carbon content has a high affinity for polymer chains (which are virtually hydrocarbon chains) that form resin. In other words, the high affinity for polymer chains (hydrocarbon chains) allows the hydrophobic AlN powder to be present inclose contact with a resin component of articles even with different resin compositions or of different resin types. Thus, the hydrophobic AlN powder exhibits high hydrolysis resistance (water resistance) also in a resin article.

Therefore, the hydrophobic aluminum nitride powder of the present invention is extremely useful as a filler for use in a resin composition for a heat dissipation material that needs to ensure high reliability under high humidity conditions.

### MODE FOR CARRYING OUT THE INVENTION

### Hydrophobic Aluminum Nitride Powder

The hydrophobic aluminum nitride powder of the present invention is made of AlN particles surface-treated with a silane compound. More specifically, a silane compound is bound to the surface of aluminum nitride particles by forming a chemical bond with a hydroxyl group or the like present on the surface (or on an oxide film formed on the surface) of aluminum nitride particles. The thus-obtained aluminum nitride powder exhibits hydrophobic properties, so that the hydrolysis of aluminum nitride (AlN) is suppressed.

In the present invention, hydrophobic properties is developed by the surface treatment with a silane compound as described above. The hydrophobicity is in a range of 1 to 45, preferably in a range of 1 to 30.

The hydrophobicity, which is also referred to as methanol wettability, is a parameter measured by a method that takes advantage of the properties of hydrophobic aluminum nitride powder that it floats in water but is completely suspended and precipitated in methanol. Specifically, 100 cc of methanol solutions are placed in beakers with a capacity of 200 cc. The methanol solutions differ from one another in methanol concentration by 1 mass %. Then, 1 g of AlN powder as a sample is added to each of the solutions (beakers), followed by stirring with a magnetic stirrer for five minutes. When 50% of the AlN powder is suspended and precipitated, the value of the volume percentage of methanol in the solution in the beaker is measured as the hydrophobicity. AlN powder with low hydrophobic properties is suspended and precipitated only in a solution of high methanol concentration.

It is also important for the hydrophobic AlN powder of the present invention that the carbon content derived from. the silane compound (hydrophobizing agent) present on the surface of particles is in a range of 0.1 to 0.5 mass %.

The carbon content is measured by a carbon analyzer after the hydrophobization treatment (surface treatment) and calculated by the following equation.

Carbon content derived from silane compound (mass %)=A×100/B
A: Carbon amount after hydrophobization treatment
B: Total mass of AlN powder after hydrophobization treatment

The carbon amount before the hydrophobization treatment is substantially zero, or if not zero, is negligibly small enough to be considered as an impurity. Thus, the carbon amount before the hydrophobization treatment may be considered to be zero, and the carbon amount per total mass of the AlN powder after the hydrophobization treatment may be taken as the carbon content derived from the silane compound.

When the powder satisfies only the hydrophobicity, it exhibits improved water resistance (hydrolysis resistance) in powder form, but its water resistance in resin is still unsatisfactory, with many agglomerated particles present to inhibit the powder from being filled into resin. Meanwhile, when the powder satisfies both the hydrophobicity and the carbon content (in the range of 0.1 to 0.5 mass %), it has improved water resistance not only in powder form but also in resin, with fewer agglomerated particles present to allow the powder to be well filled into resin. For example, in an article formed from a resin composition containing this hydrophobic AlN powder, the hydrophobic AlN powder exhibits extremely high hydrolysis resistance (water resistance in resin) against moisture penetrating through the article.

Specifically, an epoxy resin article (10 mm diameter×1.2 mm thickness) containing the hydrophobic AlN powder in an amount of 25 mass % is taken as an example. When this article is immersed in 50 g of ion exchange water for 90 hours, the decomposition rate (rate of basal hydrolysis in resin) of the AlN powder is as extremely low as 25% or less. This is because, since the hydrophobic AlN powder of the present invention satisfying the aforementioned hydrophobicity and carbon content allows a moderate amount of hydrocarbon molecules of moderate size to be distributed on the surface of particles, the affinity for polymer chains that form resin is greatly improved, allowing particles forming the AlN powder to be in close contact with resin to effectively suppress moisture penetration. As a result, the hydrophobic AlN powder has extremely high water resistance in resin. Therefore, as described in Examples below, even when the epoxy resin article has a different composition or is formed of acrylic resin instead of epoxy resin, the hydrolyzability measured in a like manner is equally low.

Needless to say, the hydrophobic AlN powder of the present invention has extremely low water resistance (hydrolyzability) also in powder form.

In the present invention, since the carbon content derived from the silane compound is roughly proportional to the density of the silnae compound bound to the surface of particles, a suitable amount of the surface treatment with the silane compound can also be indicated by the hydrophobic group density of the silane compound. For example, the hydrophobic AlN powder of the present invention suitably has a hydrophobic group density, which indicates the number of the silane compounds, in a range of 0.5 to 5.0/nm², preferably in a range of 1.0 to 4.0/nm². The hydrophobic group density can be calculated from the carbon content or obtained by ²⁹SiNMR measurement.

The silane compound (hydrophobizing agent) for use in the present invention to satisfy the aforementioned hydrophobicity and carbon content (hydrophobic group density) can be a silane compound with a relatively low hydrophobizing effect. For example, a silane compound having a moderate-sized hydrocarbon group can be used alone or in combination with one or more other such silane compounds.

Above all, a silane compound having an alkyl group or an alkylene group with a molecular weight of not more than 400 or with eight or fewer carbon atoms is particularly suitable, because it contributes to the formation of an oxidation layer on the surface of the AlN powder to increase the amount of hydroxyl groups on the surface, thereby increasing the reaction rate to achieve a higher silane compound density (Si density), as described later.

For example, in the AlN powder surface-treated with the silane compound, a part or the whole of the silane compound is bound to the surface of AlN particles by a dehydration condensation reaction with not a few hydroxyl groups of an aluminum oxide layer present on the AlN particle surface. The surface-treated AlN powder is dispersed in an organic solvent, followed by solid-liquid separation. Even after that, a certain amount of the silane exists in a powdery state without being washed away. A free silane compound that is not bound to the surface of AlN particles is usually removed when washed with the organic solvent or heated under reduced pressure, for example.

The silane compound is typically a silane compound with a reactive functional group or a silane compound without a reactive functional group.

Examples of the silane compound with a reactive functional group include the following alkoxysilanes:
3-glycidoxypropyltrimethoxysilane,
3-glycidoxypropyltriethoxysilane,
3-glycidoxypropylmethyldimethoxysilane,
3-glycidoxypropylmethyldiethoxysilane,
2-(3,4-epoxycyclohexyl)ethyltrimethoxysilane,
3-methacryloxypropyltrimethoxysilane,
3-methacryloxypropyltriethoxysilane,
3-methacryloxypropylmethyldimethoxysilane,
3-methacryloxypropylmethyldiethoxysilane,
3-acryloxypropyltrimethoxysilane,
3-mercaptopropyltrimethoxysilane,
3-aminopropyltrimethoxysilane,
3-aminopropyltriethoxysilane,
2-aminoethyl-3-aminopropyltrimethoxysilane,
2-aminoethyl-3-aminopropylmethyldimethoxysilane,
3-dimethylaminopropyltrimethoxysilane,
3-diethylaminopropyltrimethoxysilane,
3-triethoxysilyl-N-(1,3-dimethyl-butylidene) propylamine,
N-phenyl-3-aminopropyltrimethoxysilane,
vinyltrimethoxysilane,
vinyltriethoxysilane,
p-styryltrimethoxysilane, and
allyltrimethoxysilane.

Examples of the silane compound without a reactive functional group include the following alkylalkoxysilanes and arylalkoxysilanes:
methyltrimethoxysilane,
dimethyldimethoxysilane,
dimethyldiethoxysilane,
trimethylmethoxysilane,
ethyltrimethoxysilane,
n-propyltrimethoxysilane,
isobutyltrimethoxysilane,
isobutyltriethoxysilane,
n-hexyltrimethoxysilane,
n-hexyltriethoxysilane,
cyclohexyltrimethoxysilane,
cyclohexylmethyldimethoxysilane,
n-octyltriethoxysilane,
phenyltrimethoxysilane,
phenyltriethoxysilane,
diphenyldimethoxysilane,
diphenyldiethoxysilane,
trifluoropropyltrimethoxysilane, and
trifluoropropylmethyldimethoxysilane.

In addition to the aforementioned alkoxysilanes, the following chlorosilane compounds can also be used:
vinyltrichlorosilane,
methyltrichlorosilane,
dimethyldichlorosilane,
trichloromethylsilane,
ethyldimethylchlorosilane,
propyldimethylchlorosilane,
phenyltrichlorosilane,
trifluoropropyltrichlorosilane, and
isopropyldiethylchlorosilane.

The hydrophobic AlN powder of the present invention has relatively low hydrophobicity. It is unpredictable with a conventional hydrophobization technique that AlN powder with low hydrophobic properties has an extremely low rate of basal hydrolysis in resin, which is an evaluation value of water resistance in epoxy resin. It is usually understood that AlN powder surface-treated with a silane compound (hydrophobizing agent) to achieve a higher degree of hydrophobicity will equally exhibit higher water resistance in resin. However, the water resistance of AlN powder in resin is dominantly determined by the adhesion between resin and particles. When AlN powder is surface-treated with a silane compound having a highly hydrophobic group (to have a hydrophobicity as high as more than 50), the rate of basal hydrolysis in resin is not necessarily low but more than 25%.

It is suitable for the surface-treated aluminum nitride powder of the present invention that D₅₀, which is the value of the particle diameter at a cumulative volume of 50%, is 0.3 to 20 μm, preferably 0.5 to 8 μm, in the particle size distribution as measured with an ethanol solvent by a laser diffraction and scattering-type particle size distribution meter. The hydrophobic AlN powder with such a small particle diameter is particularly significantly effective as a filler in the present invention, because particles of this powder have a relatively large specific surface area and, thus, form a large interface with resin.

Further, in the hydrophobic AlN powder of the present invention, it is preferable that D₉₀, which is the value of the particle diameter at a cumulative volume of 90%, is not more than 100 μm, preferably not more than 20 μm.

Furthermore, in the surface-treated aluminum nitride powder of the present invention, it is preferable that the BET specific surface area A as measured by a single-point nitrogen adsorption method is in a range of 0.1 to 6.0 m²/g.

### Production of Hydrophobic AlN Powder

The hydrophobic AlN powder of the present invention is produced through the following steps, for example:
preparing a nonhydrophobic aluminum nitride powder as a base powder; and
mixing the base powder with a silane compound to surface-treat the base powder so that the hydrophobicity is 1 to 45, especially 1 to 30, and the carbon content derived from the silane compound is 0.1 to 0.5 mass % (or alternatively, the hydrophobic group density derived from the silane compound is 0.5 to 5.0/nm², especially 1.0 to 4.0/nm²) .

### Base Powder

The base powder is a nonhydrophobic AlN powder, i.e., a surface-untreated AlN powder, and any AlN powder produced by a conventionally known method can be used without particular limitation as the base powder. For example, the AlN powder may be produced by direct nitriding, reduction nitriding, gas-phase synthesis or the like.

It is desirable that the base powder contains fewer agglomerates regardless of the particle size distribution and the average particle diameter size. Agglomerates are likely to remain in the surface-treated hydrophobic AlN to inhibit the AlN from being filled into resin. Further, due to voids of agglomerates that remain even in a resin article, the AlN is susceptible to hydrolysis by intruding water. Furthermore, since the inside of agglomerates is hardly surface-treated, an untreated surface is exposed if agglomerates are broken after the surface treatment. Such an untreated surface is susceptible to hydrolysis and does not adapt well to resin. To avoid this, it is preferable, if needed, to disintegrate agglomerates with a ball mill, a jet mill or the like or to remove agglomerates from the base powder by dry classification or wet classification before the surface treatment.

The particle size distribution of the nonhydrophobic AlN powder as the raw material is not particularly limited, and may be determined as appropriate in prospect of the change in particle diameter due to the surface treatment for achieving a desired hydrophobic AlN powder. For example, in the particle size distribution as measured with a water solvent by a laser diffraction and scattering-type particle size distribution meter, D₅₀, which is the value of the particle diameter at a cumulative volume of 50%, is preferably in a range of not more than 20 μm.

Further, the base powder desirably has a specific surface area as measured by the BET method of not less than 0.6 m²/g.

The nonhydrophobic AlN powder may contain impurities derived from raw materials used to synthesize the AlN or impurities, such as alakaline-earth elements and rare earth elements, added during the synthesis in an amount of up to approximately 5 mass %. The nonhydrophobic AlN powder may also contain boron nitride in an amount of up to approximately 5 mass % as an impurity derived from an anti-agglomeration agent or a setter. However, such impurities should not be contained in such an amount that they significantly reduce the crystallizability of the AlN and lead to reduced thermal conductivity. The rate of nitride aluminum content in the base powder is preferably not less than 90 mass %, more preferably not less than 95 mass %, and still more preferably not less than 99 mass %.

To achieve the hydrophobic AlN powder of the present invention, it is preferable that the nonhydrophobic AlN powder as the raw material to be surface-treated has many oxidation layers on its surface so that the silane compound as a hydrophobizing agent is bound at high densities to the surface of aluminum nitride particles. However, considering that the oxidation layers reduce the thermal conductivity of the AlN powder, they are preferably provided in such an amount that the thermal conductivity is not reduced significantly. For example, when the oxidation layer has a thickness of approximately 0.005% to 0.2% of the diameter of the particle, the density of hydroxyl groups capable of reacting with the silane compound in the oxidation layer is not less than 0.8/nm².

It is preferable that the oxidation layer is formed on the surface of particles of the nonhydrophobic AlN powder as the raw material so that the AlN powder has a hydroxyl group density of 0.8 to 2/nm², especially 0.9 to 1.6/nm². If particles are subjected to an excessive oxidation treatment that results in a hydroxyl group density of more than 2/nm², the resultant surface, unlike a normal aluminum nitride surface, may be excessively oxidized, or progressively hydrolyzed and converted to aluminum hydroxide. The thus-treated surface is unfavorable, with low thermal conductivity.

The oxidation layer may be formed by natural oxidation that occurs while the AlN powder (nonhydrophobic AlN powder) is stored, or by an intentional oxidation treatment process. The oxidation treatment of the AlN powder may be performed during the production of the aluminum nitride, or in another step after the production of the aluminum nitride. For example, a nonhydrophobic AlN powder obtained by reduction nitriding has an aluminum oxide layer on its surface, because the production process includes an oxidation treatment step for the purpose of removing carbon used in the reaction. The aluminum nitride powder obtained by reduction nitriding may be further subjected to an additional oxidation treatment step.

When the oxidation treatment is performed additionally in another step, the treatment is suitably performed under the following conditions. The nonhydrophobic AlN powder (base powder) obtained by any of various methods is heated in an oxygen-containing atmosphere at a temperature of preferably 400° C. to 1,000° C., more preferably 600° C. to 900° C., for preferably to 600 minutes, more preferably 30 to 300 minutes, thereby forming an aluminum oxide layer on the surface of AlN particles. The oxygen-containing atmosphere can be, for example, an atmosphere of oxygen, air, water vapor, carbon dioxide or the like. In light of the object of the present invention, the treatment is preferably performed in air, especially under atmospheric pressure.

If the oxidation treatment is performed at a high temperature of more than 1000° C. for a longer time, a thick oxide coating may be formed on the surface of AlN particles. This aluminum oxide coating has a different coefficient of thermal expansion from the AlN as a core. Thus, the coating cannot maintain a uniform state and may be broken to expose the surface of the AlN as a core, which results in reduced hydrolysis resistance. On this account, the oxidation treatment is preferably performed under less severe conditions.

The shape of primary particles of the nonhydrophobic AlN powder as the base powder of the present invention is not particularly limited, and can be any shape such as an indefinite shape, a spherical shape, a polyhedral shape, a columnar shape, a whisker shape, or a plate shape. Among them, a spherical shape is desirable for filler use, because it ensures favorable viscosity properties and highly reproducible thermal conductivity. Further, the aspect ratio of the particles is preferably lower, suitably 1 to 3.

### Surface Treatment Step

The above-described base powder (nonhydrophobic AlN powder) is surface-treated with the silane compound, thereby providing the desired hydrophobic AlN powder of the present invention.

As described above, the surface treatment is performed so that the hydrophobicity is 1 to 45, especially 1 to 30, and the carbon content derived from the silane compound is 0.1 to 0.5 mass % (or alternatively, the hydrophobic group density derived from the silane compound is 0.5 to 5.0/nm², especially 1.0 to 4.0 nm²) . Accordingly, the usage of the silane compound is usually 0.1 to 5 parts by mass, preferably 0.2 to 1.0 parts by mass, with respect to 100 parts by mass of the aluminum nitride powder with an oxidization layer on its surface, although it varies depending on the type of the silane compound, the amount of OH groups present on the surface of particles of the nonhydrophobic AlN powder to be surface-treated, the specific surface area of the nonhydrophobic AlN powder, and the like.

The surface treatment with the silane compound is performed in the following manner: The silane compound is brought into contact with the nonhydrophobic AlN powder while being heated, followed by the removal of a free silane compound, if needed.

The contact between the nonhydrophobic AlN powder and the silane compound may be established by a dry surface treatment or a wet surface treatment.

The dry surface treatment is performed by dry mixing the aluminum nitride powder with the hydrophobizing agent without a large amount of solvent.

Dry mixing is performed by any of the following methods:
mixing the silane compound in gasified form with the base powder;
spraying or dropwise adding the silane compound in liquid form to mix the same with the base powder; and
spraying or dropwise adding the silane compound in liquid form that has been increased in amount by diluting the silane compound with a small amount of organic solvent.

The method involving gasification is applicable when the silane compound is highly volatile with a low molecular weight, for example. The method involving dilution with an organic solvent is adopted when the silane compound is too small in amount to be uniformly dispersed across the powder. In this case, if the diluent organic solvent is used in an excessive amount, the whole powder contains a large amount of liquid, which leads to agglomeration formation. In view of this, a 5- to 50-fold dilution by weight is desirable. In any case, it is important in the dry method to allow the silane compound to be uniformly spread across the base powder.

Dry mixing may be performed on heating, or alternatively a heating operation may be carried out after sufficient dry mixing is performed at room. temperature. Heating is desirably conducted for the purpose of firmly fixing the silane compound to the surface of AlN particles. However, heating at an excessively high temperature may cause the silane compound to be volatilized or excessively accelerate the condensation of the silane compounds, which may make the treatment uneven. Uniformly treated powder is more easily obtainable by performing mixing at room temperature prior to the start of heating, because the silane compound has been entirely spread before the reaction occurs. The heating temperature during or after mixing is preferably approximately 20° C. to 150° C., especially approximately 40° C. to 130° C.

The silane compound can be hydrolyzed in advance with an acid, a base or the like before being used for the surface treatment. However, it is preferable to avoid the use of an acid or a base, especially a basic substance, used for the hydrolysis, because such a substance converts the surface of AlN particles.

A dry mixing machine can be a common mixing and stirring device such as a planetary mixer, a Henschel mixer, a super mixer, a V-type mixer, a drum mixer, a double cone mixer, or a rocking mixer. Such a device desirably has a heating function, because heating while stirring results in less steps in the surface treatment.

Further, considering that dry mixing is likely to cause the agglomeration of powder, a mixing machine desirably has a mechanism for dicomposing the agglomeration once produced, like a disintegrating blade or a chopper. During a mixing operation, powder is not only attached to but also pressed against the wall of a mixing vessel in some stirring mechanisms, which may result in the formation of a thick adherent layer. In such a case, powder cannot be maintained in a mixed state. To avoid this, it is more preferable that the wall of a mixing vessel has a non-stick function like a fluorine resin coating, a mechanism for brushing off attached powder, such as a knocker, a scraping mechanism designed based on a stirring blade, or the like.

On the other hand, the wet surface treatment is performed by mixing the aluminum nitride powder with the silane compound with the use of a solvent.

As compared with the dry method, the wet method enables the hydrophobizing agent to be uniformly spread across the whole particles, so that the powder has stable properties due to the treating agent more evenly spreaded. Meanwhile, the wet method requires a drying step, which may cause the segregation of the silane compound depending on the way of drying.

The wet method includes: adding the silane compound to a solvent; dispersing the raw material AlN powder in the solvent; and, if needed, heating, removing the solvent, and drying by heating.

Heating, which is performed if needed, is intended to accelerate the reaction of the silane compound with the surface of AlN particles. Heating is suitably performed at a temperature of approximately 50° C. to 120° C. for approximately 60 to 300 minutes. As in the dry surface treatment, solvent removal may be followed by heating for the purpose of fixing the silane compound to the surface of AlN particles. The heating temperature is preferably approximately 20° C. to 150° C., especially approximately 40° C. to 130° C.

Heating may be performed under reduced pressure. Heating under reduced pressure removes the excess hydrophobizing agent, so that an excessive amount of the treatment agent is not contained, thereby preventing the powder from being agglomerated by the treatment. The reduced pressure is desirably not more than 10 hPa.

In the reaction of the AlN powder with the silane compound, it is not necessary for all reactive groups of the silane, such as alkoxy groups, to be bound to the aluminum nitride. However, when such reactive groups react with water, hydroxyl groups are formed, which may break a bond formed between the silane and AlN particles. On this account, it is not preferable to add an excessive amount of silane. It is thus preferred to adjust the amount of silane depending on the amount of surface hydroxyl groups of the aluminum nitride to react with the silane.

The surface treatment sometimes accelerates the agglomeration of the hydrophobic AlN powder to be obtained, which may degrade powder properties and inhibit the powder from being filled into resin. In such a case, it is preferable to perform a disintegration treatment or a classification treatment to remove coarse particles.

The disintegration treatment or classification treatment is preferably performed so that D₉₀, which is the value of the particle diameter at a cumulative volume of 90%, of the hydrophobic AlN powder is not more than 100 μm.

The method of disintegration is preferably dry disintegration. Additionally, relatively mild disintegration is desirable so as not to disintegrate a large part of agglomerates formed. In particular, if severe disintegration is performed with such a device and under such conditions that even primary particles are broken, the effect of the present invention is impaired.

Examples of a disintegrator includes dry disintegrators, such as a stone grinding mill, an automated mortar, a cutter mill, a hammer mill, and a pin mill. Among them, a stone grinding mill is preferred, because it allows for more even disintegration by selectively breaking large agglomerates in a short time. The disintegration treatment is desirably performed under an air atmosphere or an inert gas atmosphere. The humidity in the atmosphere is preferably not too high, specifically less than 70%, and more preferably less than 55%.

The classification treatment can be performed by either dry classification or wet classification. In a case where classification does not require high accuracy, dry classification is desirable because it can save the step of solvent removal. For the dry classification, air classification, a vibrating screen or the like can be used.

The method or device for air classification may be selected as appropriate so as to achieve a particle size distribution suitable for a filler for resin. The air classification method includes: dispersing powder in an airflow; and classifying the powder into fine powder and coarse powder with the use of the gravity, inertial force, centrifugal force and the like of dispersed particles. In particular, in a case where particles of a few micrometers are classified, suitable classification accuracy is ensured by a classifier using an inertial force and a centrifugal force.

Examples of a method using an inertial force includes an impactor type, a semi-free vortex type, and a Coanda type. The impactor type uses a guide blade or the like provided in a device to generate a swirling airflow. Powder and particle is classified into fine powder and coarse powder when forced to be curved by the airflow. The semi-free vortex type allows powder to be classified by exerting a centrifugal force on particles. The Coanda type uses the Coanda effect. Examples of a classifier using an inertial force includes a cascade impactor, a viable impactor, an aerofine classifier, an eddy classifier, an elbow jet, and a hyperplex.

A method using a centrifugal force employs a vortical airflow for classification into fine powder and coarse powder. A device for this method may be a free vortex type or a forced vortex type. Examples of the free vortex type device includes a cyclone without a guide blade, a multistage cyclone, a turbo plex using secondary air to promote deagglomeration, a dispersion separator with a guide blade for increased classification accuracy, a microspin, and a microcut. The forced vortex type device uses an inside rotating body to exert a centrifugal force on particles and allows another flow of air through the device to increase classification accuracy. Examples include a Turbo classifier and a Donaselec classifier.

It is possible to perform both the disintegration treatment and the classification treatment.

The surface treatment with the silane compound in the present invention moderately improves the hydrophobic properties of the AlN powder, thereby increasing not only the water resistance of the powder itself but also the adhesion between AlN particles, when the powder was contained in the resin. As a result, the AlN particles in a resin article are less susceptible to hydrolysis.

### Resin Composition

The hydrophobic AlN powder of the present invention exhibits excellent water resistance when filled in resin to form a resin composition. Resin for use in the formation of such a resin composition may be a thermosetting resin or a thermoplastic resin, which can be used without particular limitation. In particular, the hydrophobic AlN powder of the present invention is effectively used for resin that is likely to allow water intrusion into the matrix of the resin.

The aforementioned resin composition can contain the hydrophobic AlN powder of the present invention in an amount of 10 to 1500 parts by mass with respect to 100 parts by mass of resin. Especially, when the hydrophobic AlN powder has a particle size distribution in which D₅₀, which is the value of the particle diameter at a cumulative volume of 50%, is 0.5 to 20 μm, the resin composition preferably contains the hydrophobic AlN powder in an amount of 10 to 700 parts by mass in combination with another filler.

Examples of the thermosetting resin for use in the present invention include phenol resin, epoxy resin, melamine resin, urea resin, unsaturated polyester resin, diallyl phthalate resin, polyurethane resin, and silicone resin.

Examples of the thermoplastic resin include the following:
vinyl polymerization resin such as acrylic resin or polystyrene,
polyamide,
nylon,
polyacetal,
polycarbonate,
polyphenylene ether,
polyester such as polyethylene terephthalate,
cyclic polyolefin,
polyphenylene sulfide,
polytetrafluoroethylene,
polysulfone,
liquid crystal polymer,
polyether ether ketone,
thermoplastic polyimide, and
polyamide imide.

Among them, epoxy resin and (meth)acrylic resin are preferable in consideration of the compatibility with resin commonly and mainly used for a heat dissipation material. In addition, these resins have the advantage that they can be easily cured by heating or light irradiation in the production method described below. These resins may be used alone or in combination.

The following description is directed to epoxy resin and (meth)acrylic resin suitable for use.

### Epoxy Resin

Epoxy resin that can be used in the present invention is not particularly limited, and common epoxy resin is usable. Specific examples include:
bisphenol A type epoxy resin,
bisphenol F type epoxy resin,
phenol novolac type epoxy resin,
cresol novolac type epoxy resin,
alicyclic epoxy resin,
heterocyclic type epoxy resin,
glycidyl ester type epoxy resin,
glycidyl amine type epoxy resin,
biphenyl type epoxy resin,
naphthalene ring-containing epoxy resin, and
cyclopentadiene-containing epoxy resin.

Among them, bisphenol A type epoxy resin, bisphenol F type epoxy resin, and biphenyl type epoxy resin are preferable.

A curing agent for curing epoxy resin can be any common curing agent for epoxy resin. Specific examples include:
a thermosetting curing agent, such as amine, polyamide, imidazole, an acid anhydride, a boron trifluoride-amine complex, dicyandiamide, organic acid hydrazide, phenol novolac resin, bisphenol novolac resin, or cresol novolac resin; and
a light curing agent, such as diphenyliodonium hexafluorophosphate, or triphenylsulfonium hexafluorophosphate.

Among them, amine, imidazole, and an acid anhydride are preferable.

Specific examples of the amine curing agent include the following amine compounds:
chain aliphatic amine, such as diethylene triamine, triethylene tetramine, tetraethylene pentamine, dipropylene diamine, or diethylaminopropylamine;
cyclic aliphatic amine, such as N-aminoethylpiperazine, or isophorone diamine;
cyclic aromatic polyamine, such as m-xylene diamine; and
aromatic amine, such as metaphenylenediamine, diaminodiphenylmethane, or diaminodiphenylsulfone.

Specific examples of the imidazole curing agent include the following imidazole compounds:
2-methylimidazole,
2-ethyl-4-methylimidazole,
1-cyanoethyl-2-undecylimdazole trimellitate, and
an epoxy imidazole adduct.

Examples of the acid anhydride curing agent include the following acid anhydride compounds:
phthalic anhydride,
trimellitic anhydride,
pyromellitic anhydride,
benzophenone tetracarboxylic anhydride,
ethylene glycol bistrimellitate,
maleic anhydride,
tetrahydrophthalic anhydride,
methyltetrahydrophthalic anhydride,
methyl endomethylene tetrahydrophthalic anhydride,
methylbutenyl tetrahydrophthalic anhydride,
dodecenyl succinic anhydride,
hexahydrophthalic anhydride,
succinic anhydride,
methylcyclohexene dicarboxylic anhydride,
alkylstyrene-maleic anhydride copolymer,
chlorendic anhydride, and
polyazelaic anhydride.

In addition to the above-described epoxy resin and curing agent, a curing accelerator may also be contained for curing, if needed. Specific examples of the curing accelerator include the following compounds:
an imidazole type curing accelerator, such as imidazole, or 2-methylimidazole;
a phosphine derivative, such as triphenylphosphine, tris-p-methoxyphenylphosphine, or tricyclohexylphosphine; and
a cycloamidine derivative, such as 1,8-diazabicyclo(5.4.0)undeca-7-ene.

In a case where a mixture of the epoxy resin, the curing agent, and the curing accelerator has high viscosity, a reactive diluent having an epoxy group may also be contained. Any common reactive diluent can be used. Specific examples of the reactive diluent include the following compounds:
n-butyl glycidyl ether,
allyl glycidyl ether,
styrene oxide,
phenyl glycidyl ether,
glycidyl methacrylate,
p-sec-butylphenyl glycidyl ether,
diglycidyl ether,
(poly)ethylene glycol diglycidyl ether,
(poly)propylene glycol diglycidyl ether,
butanediol diglycidyl ether,
diglycidyl aniline, and
glycerin triglycidyl ether.

### (Meth)Acrylic Resin

(Meth)acrylic resin that can be used in the present invention is not particularly limited, and common (meth) acrylic resin is usable.

Examples of a monofunctional monomer for use in the formation of (meth)acrylic resin include the following compounds:
(meth) acrylonitrile,
(meth) acrylamide,
(meth)acrylic acid,
methyl (meth)acrylate,
ethyl (meth)acrylate,
hydroxyethyl (meth)acrylate,
butyl (meth)acrylate,
hydroxybutyl (meth)acrylate,
succinic acid 2-(meth)acryloyloxyethyl,
maleic acid 2-(meth)acryloyloxyethyl and salts thereof,
phthalic acid 2-(meth)acryloyloxyethyl,
trifluoroethyl (meth)acrylate,
perfluorobutyl ethyl (meth)acrylate,
perfluorooctyl ethyl (meth)acrylate,
(meth)acrylic acid dimethyl amino ethyl,
(meth)acrylic acid diethyl amino ethyl, and
(meth)acryloxyethyl hydrogen phosphate.

Examples of a polyfunctional monomer for use in the formation of (meth)acrylic resin include the following compounds:
ethylene glycol di(meth)acrylate,
propylene glycol di(meth)acrylate,
1,4-butanediol di(meth)acrylate,
1,6-hexanediol di(meth)acrylate,
1,9-nonanediol di(meth)acrylate,
1,10-decanediol di(meth)acrylate,
glycerol di(meth)acrylate,
tetrafluoroethyl di(meth)acrylate,
hexafluoropropyl di(meth)acrylate,
octafluorobutyl di(meth)acrylate,
bis[2-(meth)acryloxyethyl]hydrogen phosphate,
an ethylene oxide adduct of bisphenol A and di(meth)acrylate of a propylene oxide adduct,
a bisphenol A-diepoxy-acrylic acid adduct,
tricyclodecane dimethanol diacrylate,
urethane di(meth)acrylate, and
pentaerythritol (meth) acrylate.

The polyfunctional monomer can be used alone or in combination with the monofunctional monomer to form (meth)acrylic resin.

In order to polymerize and cure the (meth) acrylic monomer, a thermal radical polymerization initiator can be used.

Examples of the thermal radical polymerization initiator include the following compounds:
an organic peroxide, such as octanoyl peroxide, lauroyl peroxide, t-butylperoxy-2-ethylhexanoate, benzoyl peroxide, t-butylperoxy isobutyrate, t-butylperoxy laurate, t-hexyl peroxybenzoate, or di-t-butyl peroxide; and
an azobis type polymerization initiator, such as 2,2-azobisisobutyronitrile, or 2,2-azobis-(2,4-dimervaleronitrile).

Among the aforementioned polymerization initiators, benzoyl peroxide, t-butylperoxy-2-ethylhexanoate and the like are suitable for use for polymerization at 80° C. to 160° C.

Each of these polymerization initiators is usually used in an amount of 0.1 to 20 parts by mass, suitably 0.5 to 10 parts by mass, with respect to 100 parts by mass of the monomer.

When the curing reaction is activated by light, a known photopolymerization initiator for a (meth)acrylic group can be used.

When the hydrophobic AlN powder of the present invention is used as a filler, it maybe used in combination with another filler. Such a filler for use in combination does not necessarily have to be thermally conductive, and may have low thermal conductivity when improved filling properties can be expected.

The combined use with another filler is useful in improving filling properties of the hydrophobic AlN powder with a small particle diameter, especially with a D₅₀ of 0.5 to 8 μm as mentioned above. In such a case, another filler appropriately has a Dso of 15 to 100 μm and is preferably used in an amount in a range of 150 to 900 parts by mass with respect to 100 parts by mass of the hydrophobic AlN powder. As described below, another filler is preferably aluminum oxide.

Examples of a thermally conductive filler include aluminum oxide, boron nitride, ZnO, MgO, carbon fiber, and diamond particles.

In addition, the following substances can also be used as a thermally conductive filler: slice; quartz; talc; mica; complex oxides such as silica-titania, silica-zirconia, silica-barium oxide, silica-aluminum, silica-calcia, silica-strontium oxide, and silica-magnesia; and silicate salts such as zeolite and montmorillonite.

The aforementioned filler may be or may not be surface-treated. When another filler is surface-treated, it is preferable in terms of filling properties that a hydrophobizing agent, which has identical or similar properties to the silane compound used for the hydrophobic AlN powder of the present invention, is used for the surface treatment of the filler.

A resin article maybe formed to contain an additive known per se in addition to the filler and the resin raw material. The purpose of containing an additive is to improve the filling properties of the filler and to increase the mechanical physical properties and the like of the resin article, for example.

Such an additive is not particularly limited as long as it does not impair thermal conductivity and the adhesion between the hydrophobic AlN powder and the resin. However, the use of an additive that promotes the hydrolysis of aluminum nitride or reacts with aluminum nitride to form a different compound should be avoided. An organic solvent may also be used as long as it is removed in the final process of forming a resin article.

The aforementioned additive is particularly suitably a silane compound in terms of the compatibility with the hydrophobic AlN and other common fillers.

The silane compound is preferably contained in an amount of 0.01 to 5 parts by mass with respect to 100 parts by mass of the resin.

Specific examples of the silane compound for use as the additive include the following.

Epoxy group-containing silane, such as
3-glycidoxypropyltrimethoxysilane,
3-glycidoxypropyltriethoxysilane,
3-glycidoxypropylmethyldimethoxysilane,
3-glycidoxypropylmethyldiethoxysilane, or
2-(3,4-epoxycyclohexyl)ethyltrimethoxysilane;
   methacrylic group-containing silane, such as
3-methacryloxypropyltrimethoxysilane,
3-acryloxypropyltrimethoxysilane,
3-methacryloxypropyltriethoxysilane,
3-methacryloxypropylmethyldimethoxysilane, or
3-methacryloxypropylmethyldiethoxysilane;
   amino group-containing silane, such as
3-aminopropyltrimethoxysilane, 3-aminopropyltriethoxysilane,
2-aminoethyl-3-aminopropyltrimethoxysilane,
3-triethoxysilyl-N-(1,3-dimehyl-butylidene)propylamine,
2-aminoethyl-3-aminopropylmethyldimethoxysilane,
3-dimethylaminopropyltrimethoxysilane,
3-diethylaminopropyltrimethoxysilane, or
N-phenyl-3-aminopropyltrimethoxysilane;
alkylsilane, such as methyltrimethoxysilane, dimethyldimethoxysilane, dimethyldiethoxysilane, trimethylmethoxysilane, ethyltrimethoxysilane, n-propyltrimethoxysilane, isobutyltrimethoxysilane, isobutyltriethoxysilane, n-hexyltrimethoxysilane, n-hexyltriethoxysilane, cyclohexyltrimethoxysilane, cyclohexylmethyldimethoxysilane, n-octyltriethoxysilane, n-decyltriethoxysilane, n-hexadecyltriethoxysilane, or n-octadecyltriethoxysilane;
alkylsilane fluoride, such as trifluoropropyltrimethoxysilane, or trifluoropropylmethyldimethoxysilane;
aromatic group-containing silane, such as phenyltrimethoxysilane, phenyltriethoxysilane, diphenyldimethoxysilane, or diphenyldiethoxysilane;
mercapto group-containing silane, such as
3-mercaptopropyltrimethoxysilane, or
3-mercaptopropylmethyldimethoxysilane;
vinyl-containing silane, such as vinyltrimethoxysilane, or vinyltriethoxysilane; and
other silane compounds, such as p-styryltrimethoxysilane, allyltrimethoxysilane,
tris-(trimethoxysilylpropyl)isocyanurate,
3-isocyanatopropyltriethoxysilane, and
3-ureidopropyltriethoxysilane.

The resin composition formed from the hydrophobic AlN powder of the present invention and the resin is suitable for use as a heat dissipating resin material.

A heat dissipating resin material produced by using the hydrophobic AlN powder of the present invention can be used as, for example, a material for a heat dissipation member for effectively dissipating heat generated from a semiconductor component mounted on home appliances, vehicles, laptop PCs and the like. Specific examples include heat dissipation grease, heat dissipation gel, a heat dissipation sheet, a phase change sheet, and an adhesive. In addition, this complex material have other uses, such as an insulating layer for use in a metal base substrate, a print substrate and a flexible substrate; a semiconductor sealing material; an underfill material; a chassis; and a heat dissipation fin.

### EXAMPLES

Hereinafter, the present invention will be described more specifically by way of examples; however, the present invention is not limited to these examples.

Raw materials used and the conditions for measuring physical properties are described below.

### Raw Material AlN Powder

A1: H No. 1 grade powder manufactured by reduction nitriding by Tokuyama Corporation
   D₅₀=1.20 μm
   Specific surface area: 2.60 m²/g
   Oxygen concentration: 0.8 mass %
   Amount of surface hydroxyl groups: 1.4/nm²
A2: HF-05 grade powder manufactured by reduction nitriding by Tokuyama Corporation
   D₅₀=4.95 μm
   Specific surface area: 0.80 m²/g
   Oxygen concentration: 0.8 mass %
   Amount of surface hydroxyl groups: 1.3/nm²
A3: AlN powder produced by direct nitriding
   D₅₀=1.18 μm
   Specific surface area: 2.72 m²/g
   Oxygen concentration: 0.5 mass %
   Amount of surface hydroxyl groups: 0.3/nm²

### Aluminum Oxide

As aluminum oxide filler for use in combination with the AlN powder, A20s (average particle diameter: 22.7 μm) manufactured by Showa Denko K.K. was used.

### Hydrophobizing Agent

MMS: methyltrimethoxysilane (Tokyo Chemical Industry Co., Ltd.; >98%)
DMDS: dimethyldimethoxysilane (Tokyo Chemical Industry Co., Ltd.; >98%)
PRMS: propyltrimethoxysilane (Tokyo Chemical Industry Co., Ltd.; >98%)
HES: hexyltriethoxysilane (Tokyo Chemical Industry Co., Ltd.; >98%)
OES: octyltriethoxysilane (Tokyo Chemical IndustryCo., Ltd.; >97%)
GPS: 3-glycidoxypropyltrimethoxysilane (Tokyo Chemical Industry Co., Ltd.; >97%)
GOS: 8-glycidoxyoctyltrimethoxysilane (Shin-Etsu Chemical Co., Ltd.; >99%)
ECHS: 2-(3,4-epoxycyclohexyl)ethyltrimethoxysilane (Tokyo Chemical Industry Co., Ltd.; >97%)
MPS: 3-methacryloxypropyltrimethoxysilane (Tokyo Chemical Industry Co., Ltd.; >98%)
MOS: 8-methacryloxyoctyltrimethoxysilane (Shin-Etsu Chemical Co., Ltd.; >99%)
VMS: vinyltrimethoxysilane (Tokyo Chemical Industry Co., Ltd.; >98%)
PMS: phenyltrimethoxysilane (Tokyo Chemical Industry Co., Ltd.; >98%)
PAPS: N-phenyl-3-aminopropyltrimethoxysilane (Shin-Etsu Chemical Co., Ltd.; >95%)
AMS: 3-aminopropyltrimethoxysilane (Tokyo Chemical Industry Co., Ltd.; >97%)
AEPS: 2-aminoethyl-3-aminopropyltrimethoxysilane (Tokyo Chemical Industry Co., Ltd.; >97%)
AEOS: N-2-(aminoethyl)-8-aminooctyltrimethoxysilane (Shin-Etsu Chemical Co., Ltd.; >95%)
DMS: decyltrimethoxysilane (FUJIFILM Wako Pure Chemical Corporation; >98%)

### Epoxy Resin

Epoxy resin jER828 (manufactured by Mitsubishi Chemical Corporation)
Amine curing agent jER CureW (manufactured by Mitsubishi Chemical Corporation)

### Methacrylic Resin

BPE-100: ethoxylated bisphenol A dimethacrylate (manufactured by SHIN-NAKAMURA CHEMICAL Co., Ltd.)
3G: triethylene glycol dimethacrylate (FUJIFILM Wako Pure Chemical Corporation)

### Curing Catalyst for Methacrylic Resin

Perbutyl O: t-butylperoxy-2-ethylhexanoate (manufactured by NOF CORPORATION)

### Specific Surface Area

A specific surface area analyzer (FlowSorb II 2300 manufactured by SHIMADZU CORPORATION) was used to measure the BET specific surface area of the organic-inorganic composite particle powder based on the BET method (single-point nitrogen adsorption method). In advance of the measurement, 2 g of the organic-inorganic composite particle powder was dried in a nitrogen gas flow at 100° C. for one hour.

### Particle Size Distribution

Water is used as a solvent for the measurement of the raw material AlN. Ethanol is used as a solvent for the measurement of the hydrophobic AlN. The AlN powder is dispersed in the solvent in a concentration of 0.2 mass % , followed by ultrasonic irradiation at approximately 200 W for two minutes. The resultant dispersed liquid is subjected to the measurement of the particle size distribution with a laser diffraction and scattering-type particle size distribution meter. In the volume frequency distribution of particle diameter, D₅₀ and D₉₀ are the values of the particle diameter at cumulative volume frequencies of 50% and 90%, respectively, as accumulated from the small particle diameter side. In the present invention, D₅₀ is determined as the average particle diameter.

### Carbon Analysis, Hydrophobic Group Density

The carbon content of the hydrophobic AlN powder was measured by a carbon analyzer (e.g., EMIA-110 manufactured by HORIBA, Ltd.) The powder was burned in an oxygen stream at 1350° C. until no more carbon dioxide gas was evolved. The carbon content of the powder was determined from the amount of carbon dioxide evolved. The carbon content derived from a hydrophobized layer of the hydrophobic AlN powder was calculated from the equation described herein for calculating the carbon content derived from the silane compound. Further, the hydrophobic group density was calculated from the carbon content.

### Amount of Surface Hydroxyl Groups

The AlN powder was dry-treated with hexamethyldisilazane, and the amount of trimethylsilyl groups produced on the AlN surface was measured by carbon analysis. The thus-obtained amount was used to calculate the amount of surface hydroxyl groups.

### Oxygen Concentration of AlN Powder

The oxygen concentration of the AlN powder was measured by an oxygen analyzer manufactured by HORIBA, Ltd.

It was confirmed that at least 70% or more of oxygen was present in an oxidation layer on the surface of AlN particles.

### Decomposition Rate (Water Resistance) of AlN Powder

The raw material AlN powder or the hydrophobic AlN powder was evaluated for water resistance in the following manner. 1 g of a sample powder, together with 50 g of ion exchange water, was placed in a fluororesin container with a capacity of 50 cm³, which was then stored airtight at 25° C. for 24 hours. Thereafter, the container was opened, and the water extracted therefrom was subjected to ion chromatography, so that the amount of ammonium ions in the water was determined. Assuming that AlN was hydrolyzed in accordance with Formula (1), the decomposition rate of the AlN was calculated from the amount of substance of ammonium ions.

AlN+3H₂O→Al(OH)₃+NH₃ (1)

### Rate of Basal Hydrolysis (Water Resistance) in Resin

A resin composition was obtained by filling resin with the raw material AlN powder or the hydrophobic AlN powder as a sample AlN powder. The resin composition was subjected to a water resistance test in the following manner. The curing agent was added in an amount of 20 mass % to the epoxy resin, to which the AlN powder was added in a filling amount of 25 mass %, followed by kneading in a mortar for 15 minutes. The resultant kneaded material was subjected to hot press molding at 150° C. and 20 MPa for one hour, followed by additional heating at 180° C. for another hour for curing. The thus-cured resin composition took the form of a plate-shaped cured body with a diameter of mm and a thickness of 1.2 mm.

The thus-obtained sample (cured body), together with 50 cc of ion exchange water, was placed in a lidded fluororesin container with a capacity of 50 cc, which was then stored statically at 120° C. for 90 hours. Thereafter, the container was cooled to 10° C. and then opened. The water extracted therefrom was subjected to ion chromatography, so that the amount of ammonium ions in the water was determined. Assuming that AlN was hydrolyzed in accordance with Formula (1), the rate of basal hydrolysis in the resin was calculated from the measured value of ammonium ions.

### Water Resistance Test of Resin Composition

A resin composition was formed in the following manner and measured for decomposition rate (water resistance) in accordance with the above-described method of measuring the rate of basal hydrolysis (water resistance) in resin.

### Epoxy Resin Composition

The following raw materials were weighed and kneaded together in a mortar for 15 minutes to provide a kneaded material.
Hydrophobic AlN powder: 0.47 g
Aluminum oxide powder A20s: 1.33 g
Epoxy resin jER828: 0.12 g
Curing agent CureW: 0.03 g

The resultant kneaded material was subjected to hot press molding at 150° C. and 20 MPa for one hour, followed by additional heating at 180° C. for another hour. The thus-cured resin composition took the form of a plate-shaped cured body with a diameter of 10 mm and a thickness of 1.2 mm.

### Acrylic Resin Composition

The following raw materials were weighed and kneaded together in a mortar for 15 minutes to provide a kneaded material.
Hydrophobic AlN powder: 0.47 g
Aluminum oxide powder A20s: 1.33 g
Methacrylate monomer BPE-100: 0.105 g
3G: 0.045 g
Perbutyl O: 0.001 g

The resultant kneaded material was subjected to hot press molding at 150° C. and 20 MPa for three hours. The thus-cured resin composition took the form of a plate-shaped cured body with a diameter of 10 mm and a thickness of 1.2 mm.

### Examples 1 to 22, Comparative Examples 1 to 7

Hydrophobic AlN powders were obtained (see Table 1) by a method described in Production Example below. Each of the obtained hydrophobic AlN powders was measured for D₅₀, carbon content, hydrophobic group density, specific surface area, hydrophobicity, powder decomposition rate, and rate of basal hydrolysis in resin in accordance with the methods described above. Further, the hydrophobic AlN powder was used to produce the epoxy resin composition and the acrylic resin composition, each of which was subjected to the water resistance test. The results are summed up in Tables 2 and 3.

### Production Example

600 g of the raw material aluminum nitride powder shown in Table 1, together with 2.45 g (corresponding to 30 mmol/g) of the hydrophobizing agent shown in Table 1 and 1200 g of isopropyl alcohol, was placed in a glass recovery flask, followed by stirring with a fluororesin stirring blade for 30 minutes. The isopropyl alcohol was removed by a rotary evaporator at 50° C. under reduced pressure. The residue was dried at 100° C. under reduced pressure to provide a hydrophobic AlN powder.

### Comparative Example 8

A surface-untreated AlN powder Al was measured for hydrophobicity, powder decomposition rate, and rate of basal hydrolysis in resin. Further, the hydrophobic AlN powder was used to produce the epoxy resin composition and the acrylic resin composition, each of which was subjected to the water resistance test. The results are summed up in Tables 2 and 3.

TABLE 1-1

| | | Raw material AIN | | Hydrophobizing | |
|---|---|---|---|---|---|
| | | | Particle | agent | |
| | Production | | diameter | | Usage |
| | Example | Abbreviation | D50 (μm) | Abbreviation | (g) |
| Example 1 | Production | A1 | 1.20 | MMS | 2.45 |
| | Example 1 | | | | |
| Example 2 | Production | A1 | 1.20 | DMDS | 2.16 |
| | Example 2 | | | | |
| Example 3 | Production | A1 | 1.20 | PRMS | 3.72 |
| | Example 3 | | | | |
| Example 4 | Production | A1 | 1.20 | HES | 4.47 |
| | Example 4 | | | | |
| Example 5 | Production | A1 | 1.20 | OES | 4.98 |
| | Example 5 | | | | |
| Example 6 | Production | A1 | 1.20 | GPS | 5.01 |
| | Example 6 | | | | |
| Example 7 | Production | A1 | 1.20 | GOS | 5.52 |
| | Example 7 | | | | |
| Example 8 | Production | A1 | 1.20 | ECHS | 4.44 |
| | Example 8 | | | | |
| Example 9 | Production | A1 | 1.20 | MPS | 5.23 |
| | Example 9 | | | | |
| Example 10 | Production | A1 | 1.20 | MOS | 5.73 |
| | Example 10 | | | | |
| Example 11 | Production | A1 | 1.20 | VMS | 3.43 |
| | Example 11 | | | | |
| Example 12 | Production | A1 | 1.20 | PMS | 4.33 |
| | Example 12 | | | | |
| Example 13 | Production | A1 | 1.20 | PAPS | 4.60 |
| | Example 13 | | | | |
| Example 14 | Production | A1 | 1.20 | AMS | 3.99 |
| | Example 14 | | | | |
| Example 15 | Production | A1 | 1.20 | AEPS | 4.00 |
| | Example 15 | | | | |
| Example 16 | Production | A1 | 1.20 | AEOS | 5.27 |
| | Example 16 | | | | |
| Example 17 | Production | A2 | 4.95 | HES | 4.47 |
| | Example 17 | | | | |
| Example 18 | Production | A2 | 4.95 | OES | 4.98 |
| | Example 18 | | | | |
| Example 19 | Production | A2 | 4.95 | GPS | 5.01 |
| | Example 19 | | | | |
| Example 20 | Production | A2 | 4.95 | GOS | 5.52 |
| | Example 20 | | | | |
| Example 21 | Production | A2 | 4.95 | MPS | 5.23 |
| | Example 21 | | | | |
| Example 22 | Production | A2 | 4.95 | MOS | 5.73 |
| | Example 22 | | | | |

TABLE 1-2

| | | Raw material AIN | | Hydrophobizing | |
|---|---|---|---|---|---|
| | | | Particle | agent | |
| | Production | | diameter | | Usage |
| | Example | Abbreviation | D50 (μm) | Abbreviation | (g) |
| Comparative | Production | A1 | 1.20 | DMS | 4.73 |
| Example 1 | Example 23 | | | | |
| Comparative | Production | A3 | 1.18 | HES | 4.47 |
| Example 2 | Example 24 | | | | |
| Comparative | Production | A3 | 1.18 | OES | 4.98 |
| Example 3 | Example 25 | | | | |
| Comparative | Production | A3 | 1.18 | GPS | 5.01 |
| Example 4 | Example 26 | | | | |
| Comparative | Production | A3 | 1.18 | GOS | 5.52 |
| Example 5 | Example 27 | | | | |
| Comparative | Production | A3 | 1.18 | MPS | 5.23 |
| Example 6 | Example 28 | | | | |
| Comparative | Production | A3 | 1.18 | MOS | 5.73 |
| Example 7 | Example 29 | | | | |
| Comparative | — | A1 | 1.20 | — | — |
| Example 8 | | | | | |

TABLE 2-1

| | Hydrophobic AIN powder | | | | |
|---|---|---|---|---|---|
| | Particle | | Specific | Hydrophobic | |
| | diameter | Carbon | surface | group | |
| | D50 | content | area | density | |
| | (μm) | (wt %) | (m²/g) | (num./nm²) | Hydrophobicity |
| Example 1 | 1.29 | 0.110 | 2.40 | 2.02 | 25 |
| Example 2 | 1.30 | 0.113 | 2.31 | 2.44 | 27 |
| Example 3 | 1.25 | 0.095 | 2.42 | 1.06 | 12 |
| Example 4 | 1.23 | 0.145 | 2.38 | 1.47 | 40 |
| Example 5 | 1.21 | 0.193 | 2.34 | 1.79 | 45 |
| Example 6 | 1.28 | 0.274 | 2.42 | 2.44 | 1 |
| Example 7 | 1.27 | 0.435 | 2.28 | 3.73 | 3 |
| Example 8 | 1.31 | 0.330 | 2.38 | 3.38 | 2 |
| Example 9 | 1.26 | 0.158 | 2.45 | 1.33 | 15 |
| Example 10 | 1.28 | 0.442 | 2.32 | 3.59 | 20 |
| Example 11 | 1.26 | 0.114 | 2.46 | 1.46 | 12 |
| Example 12 | 1.25 | 0.167 | 2.43 | 1.72 | 15 |
| Example 13 | 1.28 | 0.149 | 2.49 | 1.41 | 20 |
| Example 14 | 1.33 | 0.120 | 2.35 | 1.38 | 1 |
| Example 15 | 1.35 | 0.188 | 2.30 | 2.21 | 1 |
| Example 16 | 1.37 | 0.202 | 2.28 | 1.82 | 3 |
| Example 17 | 5.01 | 0.123 | 0.74 | 4.01 | 38 |
| Example 18 | 5.03 | 0.131 | 0.73 | 3.89 | 42 |
| Example 19 | 5.11 | 0.094 | 0.74 | 2.74 | 1 |
| Example 20 | 5.18 | 0.164 | 0.69 | 4.65 | 3 |
| Example 21 | 5.08 | 0.134 | 0.73 | 3.79 | 12 |
| Example 22 | 5.13 | 0.171 | 0.68 | 4.74 | 18 |

TABLE 2-2

| | Hydrophobic AIN powder | | | | |
|---|---|---|---|---|---|
| | Particle | | Specific | Hydrophobic | |
| | diameter | Carbon | surface | group | |
| | D50 | content | area | density | |
| | (μm) | (wt %) | (m²/g) | (num./nm²) | Hydrophobicity |
| Comparative | 1.24 | 0.168 | 2.29 | 1.67 | 55 |
| Example 1 | | | | | |
| Comparative | 1.16 | 0.071 | 2.69 | 0.64 | 10 |
| Example 2 | | | | | |
| Comparative | 1.16 | 0.069 | 2.65 | 0.57 | 15 |
| Example 3 | | | | | |
| Comparative | 1.18 | 0.075 | 2.68 | 0.60 | 0 |
| Example 4 | | | | | |
| Comparative | 1.23 | 0.112 | 2.53 | 0.87 | 0 |
| Example 5 | | | | | |
| Comparative | 1.17 | 0.078 | 2.67 | 0.60 | 3 |
| Example 6 | | | | | |
| Comparative | 1.22 | 0.098 | 2.56 | 0.72 | 5 |
| Example 7 | | | | | |
| Comparative | — | — | — | 0.00 | 0 |
| Example 8 | | | | | |

TABLE 3-1

| | Hydrophobic AIN powder | | Epoxy resin | Acrylic resin |
|---|---|---|---|---|
| | Powder | Basal | Decom- | Decom- |
| | decomposition | hydrolysis | position | position |
| | rate (%) | rate (%) | rate (%) | rate (%) |
| Example 1 | 0.00 | 23.1 | 22.3 | 18.3 |
| Example 2 | 0.00 | 22.6 | 21.7 | 16.1 |
| Example 3 | 0.10 | 10.9 | 10.2 | 9.6 |
| Example 4 | 0.00 | 7.1 | 6.5 | 6.1 |
| Example 5 | 0.00 | 6.3 | 5.8 | 4.8 |
| Example 6 | 0.06 | 18.0 | 17.3 | 21.3 |
| Example 7 | 0.01 | 4.1 | 3.6 | 7.8 |
| Example 8 | 0.10 | 19.9 | 19.2 | 22.5 |
| Example 9 | 0.00 | 24.8 | 24.3 | 12.8 |
| Example 10 | 0.00 | 6.1 | 5.5 | 5.2 |
| Example 11 | 0.00 | 13.4 | 12.8 | 11.6 |
| Example 12 | 0.00 | 11.9 | 11.2 | 8.3 |
| Example 13 | 0.00 | 4.2 | 3.9 | 12.6 |
| Example 14 | 1.07 | 15.5 | 14.8 | 21.8 |
| Example 15 | 0.47 | 12.9 | 12.2 | 20.1 |
| Example 16 | 2.55 | 24.8 | 24.1 | 23.7 |
| Example 17 | 0.00 | 12.3 | 11.5 | 10.8 |
| Example 18 | 0.00 | 11.4 | 10.9 | 9.9 |
| Example 19 | 0.10 | 18.8 | 18.3 | 22.9 |
| Example 20 | 0.00 | 10.4 | 9.8 | 11.6 |
| Example 21 | 0.00 | 24.9 | 24.2 | 14.6 |
| Example 22 | 0.10 | 11.0 | 10.3 | 7.1 |

TABLE 3-2

| | Hydrophobic AIN powder | | Epoxy resin | Acrylic resin |
|---|---|---|---|---|
| | Powder | Basal | Decom- | Decom- |
| | decomposition | hydrolysis | position | position |
| | rate (%) | rate (%) | rate (%) | rate (%) |
| Comparative | 0.00 | 33.9 | 32.1 | 29.6 |
| Example 1 | | | | |
| Comparative | 52.1 | 31.6 | 30.3 | 29.1 |
| Example 2 | | | | |
| Comparative | 45.6 | 30.8 | 29.1 | 28.4 |
| Example 3 | | | | |
| Comparative | 81.3 | 33.5 | 32.5 | 40.6 |
| Example 4 | | | | |
| Comparative | 68.6 | 31.8 | 30.6 | 37.2 |
| Example 5 | | | | |
| Comparative | 96.5 | 59.1 | 56.8 | 30.5 |
| Example 6 | | | | |
| Comparative | 72.1 | 54.6 | 52.4 | 29.6 |
| Example 7 | | | | |
| Comparative | 100 | 62.7 | 61.5 | 58.3 |
| Example 8 | | | | |

1. A hydrophobic aluminum nitride powder having a hydrophobicity of 1 to 45, wherein
a carbon content derived from a hydrophobizing agent is in a range of 0.1 to 0.5 mass %, and
the hydrophobizing agent is a silane compound.

2. The hydrophobic aluminum nitride powder according to claim 1, wherein the silane compound has a molecular weight of not more than 400.

3. The hydrophobic aluminum nitride powder according to claim 1, having a hydrophobicity in a range of 1 to 30.

4. The hydrophobic aluminum nitride powder according to claim 1, wherein a particle diameter D₅₀ at a cumulative volume of 50% is 0.5 to 20 μm in a particle size distribution as measured with an ethanol solvent by a laser diffraction and scattering-type particle size distribution meter.

5. The hydrophobic aluminum nitride powder according to claim 1, wherein a decomposition rate of aluminum nitride is 25% or less as measured after a test where an article with a diameter of 10 mm and a thickness of 1.2 mm that is formed from a resin composition containing the hydrophobic aluminum nitride powder in an amount of 25 parts by mass with respect to 100 parts by mass of an epoxy resin containing an amine curing agent in an amount of 20 mass % is immersed in 50 g of ion exchange water at 120° C. for 90 hours.

6. A resin composition comprising a hydrophobic aluminum nitride powder according to claim 1.

7. The resin composition according to claim 6, comprising the hydrophobic aluminum nitride powder in an amount of 10 to 1500 parts by mass with respect to 100 parts by mass of a resin.

8. The resin composition according to claim 7, wherein the resin is an epoxy resin or a (meth)acrylic resin.

9. A method for producing a hydrophobic aluminum nitride powder, comprising the following steps:
preparing a nonhydrophobic aluminum nitride powder as a base powder; and
mixing the base powder with a silane compound to surface-treat the base powder so that a hydrophobicity is 1 to 45 and a carbon content derived from the silane compound is in a range of 0.1 to 0.5 mass %.

10. The method for producing a hydrophobic aluminum nitride powder according to claim 9, wherein the silane compound has a molecular weight of not more than 400.
